(19) United States
(12) Patent Application Publication
(10) Pub. No.: US 2013/0141284 A1
(43) Pub. Date: Jun. 6, 2013

(54) RFIC ANTENNA PACKAGE FOR MILLIMETER BAND AND RF MODULE INCLUDING THE SAME

(71) Applicant: Samsung Electro-Mechanics Co. Ltd., Gyeonggi-do (KR)

(72) Inventor: Chan Yong Jeong, Seoul (KR)

(73) Assignee: SAMSUNG ELECTRO-MECHANICS CO., LTD., Gyeonggi-do (KR)

(21) Appl. No.: 13/705,077

(22) Filed: Dec. 4, 2012

(30) Foreign Application Priority Data
Dec. 5, 2011 (KR) 10-2011-0129135

(51) Int. Cl. H01Q 1/38

(52) U.S. Cl. CPC H01Q 1/38
USPC 343/700 MS

(57) ABSTRACT

Disclosed herein are a radio frequency integrated circuit (RFIC) antenna package for a millimeter band and an RF (radio frequency) module including the same. The RFIC antenna package for a millimeter band includes: a substrate configured of at least one layer and including a circuit pattern and a via; a cavity provided at the uppermost portion of the substrate; an RFIC inserted into the cavity to thereby be electrically connected to the circuit pattern; at least one patch antenna provided at a region of the uppermost portion of the substrate except for the cavity; and a solder ball provided on a lower surface of the lowermost portion of the substrate.

### CROSS REFERENCE(S) TO RELATED APPLICATIONS

This application claims the benefit under 35 U.S.C. Section 119 of Korean Patent Application Serial No. 10-2011-0129135, entitled “RFIC Antenna Package for Millimeter Band and RF Module Including the Same” filed on Dec. 5, 2011, which is hereby incorporated by reference in its entirety into this application.

### BACKGROUND OF THE INVENTION

1. Technical Field

The present invention relates to a radio frequency integrated circuit (RFIC) antenna package for a millimeter band and a radio frequency (RF) module including the same.

2. Description of the Related Art

In accordance with a high speed radio frequency (RF) communication technology, a communication scheme in a millimeter band using a frequency of 10 GHz or more has been spotlighted.

The communication scheme in a millimeter band as described above has a rapid data rate of theoretically about 7 Gbps.

In addition, since a frequency that is out of a frequency band of 2.4 to 5 GHz that has been already used widely for purposes such as a 3G network, a wireless local area network (LAN), ZigBee communication, and the like, is used, there is almost no risk of interference and crosstalk with existing communication channels.

Meanwhile, in the communication scheme in a millimeter band as described above, due to characteristics of signal processing, loss of a signal needs to be minimized. At the same time, in accordance with the recent trend toward miniaturization and thinness of information technology (IE) devices, miniaturization of a RF module capable of performing communication in a millimeter band has been demanded.

Generally, the RF module performing the RF communication in the millimeter band may be implemented by mounting a function chip, a baseband chip, a radio frequency integrated circuit (RFIC) antenna package, and the like, on a base substrate, as shown in FIG. 1. In this case, since the RFIC antenna package among them has the largest size, miniaturization and slimness of the RFIC antenna package are absolutely required in order to miniaturize and slim the RF module.

However, the RFIC antenna package for a millimeter band should include a predetermined number or more of patch antennas and satisfy requirement for the number of connection terminals required as less as possible in mounting the RFIC antenna package on the base substrate.

Furthermore, in order to minimize loss of signals of the patch antennas used in the RFIC antenna package, the patch antennas should be disposed to be sufficiently spaced apart from each other, a physical obstacle should not be present on movement paths of signals generated from the patch antennas, and a connection distance between the patch antenna and an RFIC should be minimized.

These conditions have become limitation elements in miniaturizing and slimming the package.

### SUMMARY OF THE INVENTION

An object of the present invention is to provide a radio frequency integrated circuit (RFIC) antenna package for a millimeter band capable of decreasing loss of a signal and being miniaturized and slimmed, and a module including the same.

According to an exemplary embodiment of the present invention, there is provided a radio frequency integrated circuit (RFIC) antenna package for a millimeter band, including: a substrate configured of at least one layer and including a circuit pattern and a via; a cavity provided at the uppermost portion of the substrate; an RFIC inserted into the cavity to thereby be electrically connected to the circuit pattern; at least one patch antenna provided at a region of the uppermost portion of the substrate except for the cavity; and a solder ball provided on a lower surface of the lowermost portion of the substrate.

A height from a lower surface of the patch antenna to an upper surface of the RFIC may be less than ½ of a distance between the patch antenna and the RFIC.

The circuit pattern and the solder ball may be electrically connected to each other by a via.

According to another exemplary embodiment of the present invention, there is provided an RFIC antenna package for a millimeter band, including: an RFIC; a first substrate including a through-hole penetrating through upper and lower surfaces thereof; an electrode pattern provided on an upper surface of the first substrate; a patch antenna coupled to the electrode pattern so as to electrically contact the electrode pattern; and a second substrate including a first circuit pattern formed on an upper surface thereof and a solder ball coupled to a lower surface thereof, the first circuit pattern and the solder ball being electrically connected to each other by a via, wherein the lower surface of the first substrate and the upper surface of the second substrate are coupled to each other, wherein the RFIC is accommodated in a cavity formed by the through-hole and the second substrate to thereby be electrically connected to the first circuit pattern, and wherein the electrode pattern and the first circuit pattern are electrically connected to each other by a via penetrating through the first substrate.

A height from a lower surface of the patch antenna to an upper surface of the RFIC may be less than ½ of a distance between the patch antenna and the RFIC.

According to still another exemplary embodiment of the present invention, there is provided an RFIC antenna package for a millimeter band, including: an RFIC; a first substrate including a through-hole penetrating through upper and lower surfaces thereof; an electrode pattern provided on an upper surface of the first substrate; a patch antenna coupled to the electrode pattern so as to electrically contact the electrode pattern; a second substrate including a first circuit pattern formed on an upper surface thereof and a solder ball coupled to a lower surface thereof, the first circuit pattern and the solder ball being electrically connected to each other by a via; and an intermediate substrate including a second circuit pattern provided on the uppermost surface thereof, coupled to the lower surface of the first substrate, and having the lowermost surface coupled to the upper surface of the second substrate, the second circuit pattern and the first circuit pattern being electrically connected to each other by a via, wherein the RFIC is accommodated in a cavity formed by the through-hole and the uppermost surface of the intermediate substrate to thereby be electrically connected to the second circuit pattern, and wherein the electrode pattern and the second circuit pattern are electrically connected to each other by a via penetrating through the first substrate.

A height from a lower surface of the patch antenna to an upper surface of the RFIC may be less than ½ of a distance between the patch antenna and the RFIC.

According to still another exemplary embodiment of the present invention, there is a radio frequency (RF) module including the RFIC antenna package for a millimeter band, including: a baseband chip; the RFIC antenna package for a millimeter band as described above; and a base substrate having the RFIC antenna package for a millimeter band and the baseband chip mounted on a surface thereof or at an inner portion thereof.

### BRIEF DESCRIPTION OF THE DRAWINGS

FIG. 1 is a view schematically showing a radio frequency (RF) module for a millimeter band according to an exemplary embodiment of the present invention;

FIG. 2 is a view schematically showing a radio frequency integrated circuit (RFIC) antenna package for a millimeter band according to the exemplary embodiment of the present invention;

FIGS. 3A and 3B are, respectively, a plan view and a bottom view schematically showing the RFIC antenna package for a millimeter band according to the exemplary embodiment of the present invention;

FIG. 4 is a cross-sectional view taken along the line I-I′ of FIG. 3A;

FIG. 5 is a view describing a signal radiation angle of an antenna of FIG. 4; and

FIG. 6 is a partially enlarged view of FIG. 5.

### DESCRIPTION OF THE PREFERRED EMBODIMENTS

Various advantages and features of the present invention and methods accomplishing thereof will become apparent from the following description of exemplary embodiments with reference to the accompanying drawings. However, the present invention may be modified in many different forms and it should not be limited to exemplary embodiments set forth herein. These exemplary embodiments may be provided so that this disclosure will be thorough and complete, and will fully convey the scope of the invention to those skilled in the art. Like reference numerals throughout the description denote like elements.

Terms used in the present specification are for explaining exemplary embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

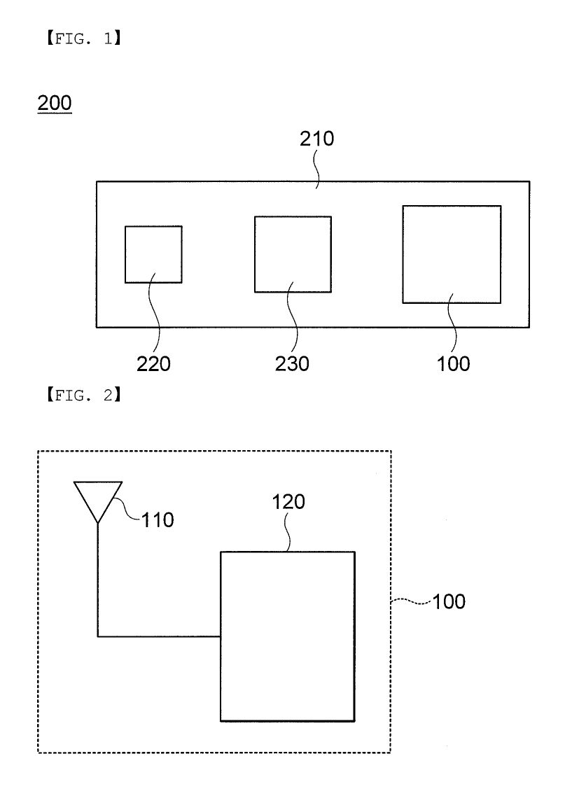

FIG. 1 is a view schematically showing a radio frequency (RF) module 200 for a millimeter band according to an exemplary embodiment of the present invention.

Referring to FIG. 1, the RF module 200 including a radio frequency integrated circuit (RFIC) antenna package 100 for a millimeter band according to the exemplary embodiment of the present invention may be configured to include a baseband chip 230, the RFIC antenna package 100 for a millimeter band, and a base substrate 210 having the RFIC antenna package 100 for a millimeter band and the baseband chip 230 mounted on a surface thereof or at an inner portion thereof.

In addition, a function chip 220 such as an image processing chip, or the like, processing data such as a high definition moving picture, or the like, input through a high definition multimedia interface (HDMI) terminal, or the like may be further mounted on the base substrate 210.

Meanwhile, the RF module 200 including an RFIC antenna package 100 for a millimeter band according to the exemplary embodiment of the present invention may minimize loss of a signal in RF communication in a millimeter band and include a miniaturized and slimmed RFIC antenna package 100 for a millimeter band to thereby be miniaturized and slimmed.

Hereinafter, a configuration and an acting effect of an RFIC antenna package 100 for a millimeter band according to the exemplary embodiment of the present invention will be described in more detail with reference to the accompanying drawings.

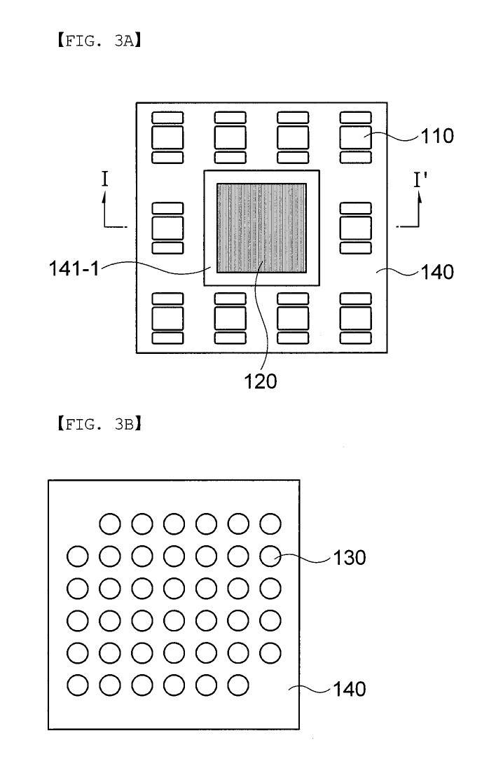

FIG. 2 is a view schematically showing an RFIC antenna package 100 for a millimeter band according to the exemplary embodiment of the present invention.

Referring to FIG. 2, the RFIC antenna package 100 for a millimeter band according to the exemplary embodiment of the present invention may be configured to include a patch antenna 110 and an RFIC 120 processing an RF signal transmitted and received through the patch antenna 110.

In an RF communication process of a millimeter band using a frequency of 10 GHz or more, a frequency signal of 10 GHz or more is transferred between the patch antenna 110 and the RFIC 120. In this case, in order to minimize loss of the signal, a distance between the patch antenna 110 and the RFIC 120 needs to be as short as possible.

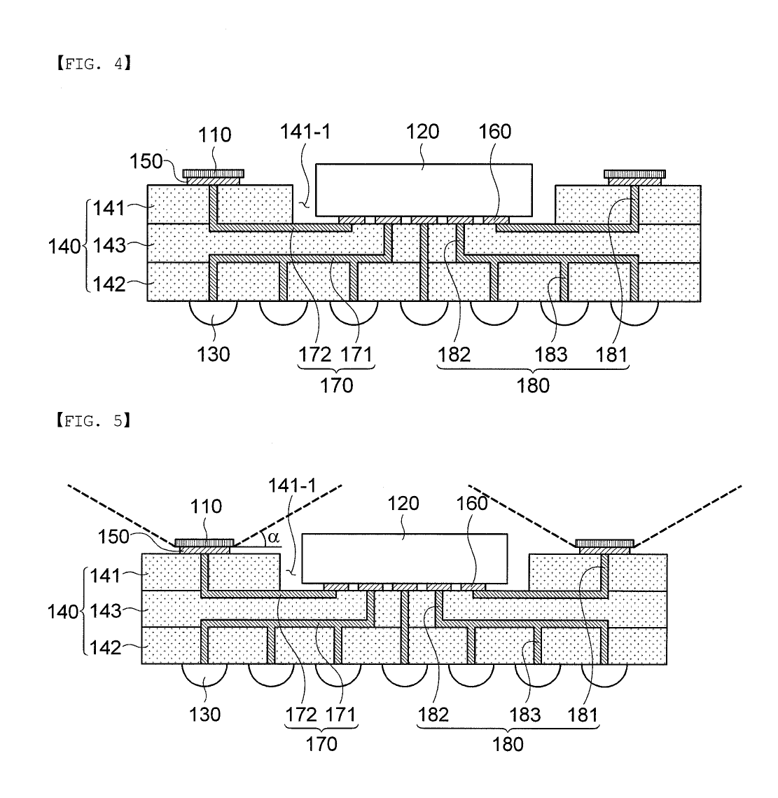

FIGS. 3A and 3B are, respectively, a plan view and a bottom view schematically showing the RFIC antenna package 100 for a millimeter band according to the exemplary embodiment of the present invention.

Referring to FIGS. 3A and 3B, the RFIC antenna package 100 for a millimeter band according to the exemplary embodiment of the present invention may be configured to include a substrate 140, patch antennas 110, an RFIC 120, and solder balls 130.

The center of the uppermost portion of the substrate 140 may be provided with a cavity 141-1 to accommodate the RFIC 120 therein, and an upper surface of the substrate 140 around the cavity 141-1 may be provided with a plurality of patch antennas 110.

In addition, a lower surface of the substrate 140 may be provided with a plurality of solder balls 130 to receive data for transmission from the base substrate 210 having the RFIC antenna package 100 for a millimeter band mounted thereon and transfer the data to the RFIC 120.

FIG. 4 is a cross-sectional view taken along the line I-I′ of FIG. 3A.

Referring to FIG. 4, the substrate 140 may include a first substrate 141, a second substrate 142, and an intermediate substrate 143.

The first substrate 141, which is provided at the uppermost portion of the RFIC antenna package 100 for a millimeter band, may include a through-hole penetrating through upper and lower surfaces thereof.

In addition, the upper surface of the first substrate 141 may be provided with an electrode pattern 150 to thereby be coupled to the patch antenna 110 so as to electrically contact the patch antenna 110.

The second substrate 142, which is provided at a lowermost portion of the RFIC antenna package 100 for a millimeter band, may include a first circuit pattern 171 formed on an upper surface thereof and the solder ball 130 provided on a lower surface thereof, wherein the first circuit pattern 171 and the solder ball 130 may be electrically connected to each other by a via 183.

The intermediate substrate 143 may be provided between the first and second substrates 141 and 142 and be implemented as a single layer or plural layers.

The uppermost surface of the intermediate substrate 143 may be provided with a second circuit pattern 172 to thereby be coupled to the lower surface of the first substrate 141, and the lowermost surface of the intermediate substrate 143 may be coupled to the upper surface of the second substrate 142.

Here, the second circuit pattern 172 and the first circuit pattern 171 may be electrically connected to each other by a via 182.

In addition, the second circuit pattern 172 and the electrode pattern 150 may be electrically connected to each other by a via 181 penetrating through the first substrate 141.

Meanwhile, the cavity 141-1 may be formed by the through-hole of the first substrate 141 and the uppermost surface of the intermediate substrate 143, and the RFIC 120 may be accommodated in the cavity 141-1 to thereby be electrically connected to the second circuit pattern 172. Here, the RFIC 120 may be coupled to the intermediate substrate 143 by a scheme such as a flip-chip bonding scheme, or the like.

Therefore, the RFIC 120 and the patch antenna 110 may be electrically connected to each other through the second circuit pattern 172, the via 181, and the electrode pattern 150, such that a connection path therebetween may be minimized.

Meanwhile, although the case in which the intermediate substrate 143 is formed as a single layer is shown in FIG. 4, the intermediate substrate 143 may be formed as plural layers as needed, and the first and second substrates 141 and 142 may be directly coupled to each other without the intermediate substrate 143.

In addition, terminals of the RFIC 120 may also be directly connected to the solder balls 130 by the via 180 rather than through the first or second circuit pattern 171 or 172.

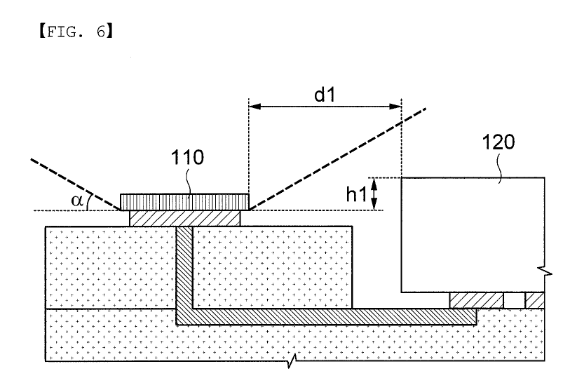

FIG. 5 is a view describing a signal radiation angle of an antenna 110 of FIG. 4; and FIG. 6 is a partially enlarged view of FIG. 5.

Referring to FIGS. 5 and 6, the patch antenna 110 basically radiates an RF signal toward an upper surface. In this case, a radiation angle of a signal meaningful in view of loss of the signal is defined as α. In other words, even though signals radiated at an angle smaller than α is subjected to physical interference in a progress process thereof, they do not have an effect on the entire loss of the signals. The radiation angle α of the signal has a fine difference according to a design, but may be generally considered to be about 30 degrees.

Meanwhile, in the case in which the patch antenna 110 and the RFIC 120 are disposed on the same surface of the package, the RF signal radiated from the patch antenna 110 may be subjected to interference by the RFIC 120. Due to the interference, the loss of the signal may be generated.

Therefore, in the RFIC antenna package 100 for a millimeter band according to the exemplary embodiment of the present invention, a height h1 from a lower surface of the patch antenna 110 to an upper surface of the RFIC 120 is allowed to be tan α times less than a distance d1 between the patch antenna 110 and the RFIC 120 so that the interference is not generated. That is, a relationship of d1/h1<tan α may be satisfied.

In this case, in consideration that the radiation angle of the signal is generally 30 degrees, d1/h1 may be less than ½.

Generally, the RFIC 120 has a thickness significantly thicker than that of the patch antenna 110. Therefore, in order to satisfy the above-mentioned condition, the cavity 141-1 is provided, and the RFIC 120 is inserted into the cavity 141-1.

In addition, the cavity 141-1 is provided to prevent a problem that a bonding material, a molding material, or the like, contaminates the patch antenna 110 in a process of the RFIC 120, thereby making it possible to improve reliability and manufacturing efficiency.

The patch antenna 110 and the RFIC 120 are provided on the same surface of the package as described above, such that a required number of solder balls 130 for transferring data are provided in a narrower region as compared with the related art, thereby making it possible to decrease the entire area of the package as compared with the related art.

In addition, the cavity 141-1 is provided, thereby making it possible to decrease a thickness of the package as compared with the related art.

Further, even though the area and the thickness of the package are decreased, the loss of the signal radiated from the patch antenna 110 may be minimized.

With the RFIC antenna package for a millimeter band according to the exemplary embodiments of the present invention configured as described above, the patch antenna and the RFIC are provided on the same surface of the package, such that a required number of solder balls for transferring data are provided in a narrower region as compared with the related art, thereby making it possible to decrease the entire area of the package as compared with the related art.

In addition, the cavity is provided, thereby making it possible to decrease a thickness of the package as compared with the related art. Further, even though the area and the thickness of the package are decreased, the loss of the signal radiated from the patch antenna may be minimized.

The present invention has been described in connection with what is presently considered to be practical exemplary embodiments. Although the exemplary embodiments of the present invention have been described, the present invention may also be used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A radio frequency integrated circuit (RFIC) antenna package for a millimeter band, comprising:
a substrate configured of at least one layer and including a circuit pattern and a via;
a cavity provided at the uppermost portion of the substrate;
an RFIC inserted into the cavity to thereby be electrically connected to the circuit pattern;
at least one patch antenna provided at a region of the uppermost portion of the substrate except for the cavity; and
a solder ball provided on a lower surface of the lowermost portion of the substrate.

2. The RFIC antenna package for a millimeter band according to claim 1, wherein a height from a lower surface of the patch antenna to an upper surface of the RFIC is less than ½ of a distance between the patch antenna and the RFIC.

3. The RFIC antenna package for a millimeter band according to claim 2, wherein the circuit pattern and the solder ball are electrically connected to each other by a via.

4. An RFIC antenna package for a millimeter band, comprising:
an RFIC;
a first substrate including a through-hole penetrating through upper and lower surfaces thereof;
an electrode pattern provided on an upper surface of the first substrate;
a patch antenna coupled to the electrode pattern so as to electrically contact the electrode pattern; and
a second substrate including a first circuit pattern formed on an upper surface thereof and a solder ball coupled to a lower surface thereof, the first circuit pattern and the solder ball being electrically connected to each other by a via,
wherein the lower surface of the first substrate and the upper surface of the second substrate are coupled to each other,
wherein the RFIC is accommodated in a cavity formed by the through-hole and the second substrate to thereby be electrically connected to the first circuit pattern, and
wherein the electrode pattern and the first circuit pattern are electrically connected to each other by a via penetrating through the first substrate.

5. The RFIC antenna package for a millimeter band according to claim 4, wherein a height from a lower surface of the patch antenna to an upper surface of the RFIC is less than ½ of a distance between the patch antenna and the RFIC.

6. An RFIC antenna package for a millimeter band, comprising:
an RFIC;
a first substrate including a through-hole penetrating through upper and lower surfaces thereof;
an electrode pattern provided on an upper surface of the first substrate;
a patch antenna coupled to the electrode pattern so as to electrically contact the electrode pattern;
a second substrate including a first circuit pattern formed on an upper surface thereof and a solder ball coupled to a lower surface thereof, the first circuit pattern and the solder ball being electrically connected to each other by a via; and
an intermediate substrate including a second circuit pattern provided on the uppermost surface thereof, coupled to the lower surface of the first substrate, and having the lowermost surface coupled to the upper surface of the second substrate, the second circuit pattern and the first circuit pattern being electrically connected to each other by a via,
wherein the RFIC is accommodated in a cavity formed by the through-hole and the uppermost surface of the intermediate substrate to thereby be electrically connected to the second circuit pattern, and
wherein the electrode pattern and the second circuit pattern are electrically connected to each other by a via penetrating through the first substrate.

7. The RFIC antenna package for a millimeter band according to claim 6, wherein a height from a lower surface of the patch antenna to an upper surface of the RFIC is less than ½ of a distance between the patch antenna and the RFIC.

8. A radio frequency (RF) module including the RFIC antenna package for a millimeter band, comprising:
a baseband chip;
the RFIC antenna package for a millimeter band according to any one of claims 1 to 7; and
a base substrate having the RFIC antenna package for a millimeter band and the baseband chip mounted on a surface thereof or at an inner portion thereof.
